(19) United States
(12) Patent Application Publication
(10) Pub. No.: US 2011/0006490 A1
(43) Pub. Date: Jan. 13, 2011

(54) CHUCK WITH JAW FOR WORKPIECE HAVING CONSTANT HOLDING FORCE

(75) Inventors: Madhav Puppala, Lisle, IL (US); Jyi-Jiin Luo, Morton Grove, IL (US); Christof Rauen, Mettmann (DE); Erwin Bohler, Bettwiesen (CH); Bodo Kaleja, Ratingen (DE)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS INC., Glenview, IL (US)

(21) Appl. No.: 12/831,887

(22) Filed: Jul. 7, 2010

Related U.S. Application Data
(60) Provisional application No. 61/225,008, filed on Jul. 13, 2009.

(51) Int. Cl. B23B 31/10; B23Q 17/00

(52) U.S. Cl. 279/126; 279/134

(57) ABSTRACT

A rotatable chuck for securing a workpiece in a machine includes a base element having a center and a plurality of jaw elements movable relative to the center. The jaw elements are movable to clamp the workpiece. The jaw elements exert a measurable clamping force on the workpiece. The clamping force exerted on the workpiece is measured and the jaw elements are moved relative to the center to vary the clamping force exerted on the workpiece. A comparator compares the measured clamping force to a predetermined clamping force and the jaw elements are moved, as the chuck is rotating, to adjust the clamping force on the workpiece relative to the predetermined clamping force.

### CROSS-REFERENCE TO RELATED APPLICATION

This application claims the benefit of priority of Provisional U.S. Patent Application Ser. No. 61/225,008, filed Jul. 13, 2009, entitled “CHUCK WITH JAW FOR WORKPIECE HAVING CONSTANT HOLDING FORCE”.

### BACKGROUND OF THE INVENTION

The present invention is directed to a jaw for use in a machine operating on a workpiece. More particularly, the present invention is directed to a chuck with a jaw for use in a machine in which a jaw exerts a constant holding force on the workpiece.

In machines that operate on a rotating workpiece, such as lathes and the like, typically, the workpiece is held in a chuck to rotate the workpiece relative to a tool (such as a blade) so that the tool can operate on the workpiece. The chuck, which is comprised of multiple moveable or adjustable jaws (often three jaws), exerts a force on the workpiece to secure or clamp the workpiece in the chuck between the jaws.

There are three commonly used chuck arrangements. The first is an arrangement in which the jaws grip the workpiece on an outer surface such that the gripping force is an inwardly exerted force. That is, the jaws move inward, toward the workpiece to effect the grip. This is referred to as an external grip chuck.

The second arrangement is one in which the jaws grip an internal surface of the workpiece, such as that which may be used to grip a hollow shaft or a bushing for machining the outer surface of the shaft or bushing. In this arrangement, the jaws gripping the interior surface exert an outward force, that is they move outwardly, toward the workpiece to effect the grip.

The third arrangement is one in which the workpiece is gripped in an axial direction, as when an end of the workpiece is gripped. This third arrangement is referred to as axial gripping.

In the external grip chuck arrangement, the workpiece is typically clamped by the jaws at a very high initial clamping force. With an exterior grip chuck, this compensates for the loss of clamping force as the chuck rotates. The clamping force decreases with increased rotational speed of the chuck. Because the clamping force decreases with increased rotational speed, the maximum velocity of the chuck (and thus, the workpiece) is limited.

The initial clamping force is, however, limited by the materials and structure of the chuck and by the need to preclude permanent distortion of the workpiece. Thus, there is a balance between the upper end of the initial clamping force that can be exerted on the workpiece and the maximum rotational or operating speed of the chuck and machine tool.

With the internal grip arrangement, the workpiece is initially gripped at a low clamping force to compensate for the increased clamping force as the chuck rotates. This limits the maximum velocity of the chuck as the clamping load continuously increases as the speed of the chuck increases. Here, permanent distortion of the workpiece can occur if the rotational speed of the chuck is too high due to the increase in the clamping force.

In the axial grip arrangement, the jaws tend to pull back toward the body of the chuck (outward) as the speed of the chuck increases. Excessive axial gripping force on the workpiece can result in distortion of the workpiece, which can cause poor machining quality. In contrast, insufficient axial force on the workpiece can allow the workpiece to move during machining also causing poor quality machining.

Accordingly, there is a need for a chuck with a jaw arrangement for a machine tool that permits high chuck rotational speeds. Desirably, such an arrangement does not exert overly high initial clamping forces so as to prevent overly stressing the jaws (and chuck) and to prevent distorting the workpiece. More desirably, such a jaw arrangement exerts a constant clamping force on the workpiece along a wide range of rotational (operating) speeds of the machine and the chuck. More desirably still, such a jaw arrangement can be used with internal, external, and axial gripping arrangements.

### BRIEF SUMMARY OF THE INVENTION

A rotatable chuck secures a workpiece in a machine, such as a lathe. The chuck includes a base element having a center and a plurality of jaw elements movable relative to the center. The jaw elements are movable to clamp and release the workpiece. The chuck can be configured for an external grip arrangement, an internal grip arrangement, or an end grip (axial grip) arrangement. The jaw elements exert a measurable clamping force on the workpiece.

Means for measuring the clamping force exerted on the workpiece includes, for example, a load cell or strain gauge. Preferably, the means is located on or near a respective jaw element. The chuck includes means for moving the jaw elements relative to the center and/or varying the clamping force exerted on the workpiece. Such means can be, for example, a hydraulic system, a mechanical system, or the like, that controls the movement of the jaw elements. The measured clamping force is compared to a predetermined clamping force.

The jaw elements are movable, both when the chuck is stationary and as the chuck is moving, to adjust the clamping force on the workpiece to the predetermined clamping force. In a present chuck, the clamping force is adjusted to maintain a substantially constant clamping force on the workpiece throughout chuck rotation at varying rotational speeds.

Preferably, the comparison means is a controller, and a wireless transmitter is used to transmit the measured clamping force. The transmitter is disposed on, or proximal to, a respective jaw element.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is an illustration of a chuck configured with an external gripping arrangement, with a jaw arrangement in which the jaws exert a constant clamping force;

FIG. 2 is an enlarged view of one of the top jaws of the chuck of FIG. 1 for holding the workpiece;

FIG. 3 is an alternate embodiment of a chuck with an external gripping arrangement for exerting a constant clamping force;

FIG. 4 is an embodiment of a chuck with an internal gripping arrangement for exerting a constant clamping force; and

FIG. 5 is an embodiment of a chuck with an axial gripping arrangement for exerting a constant clamping force.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

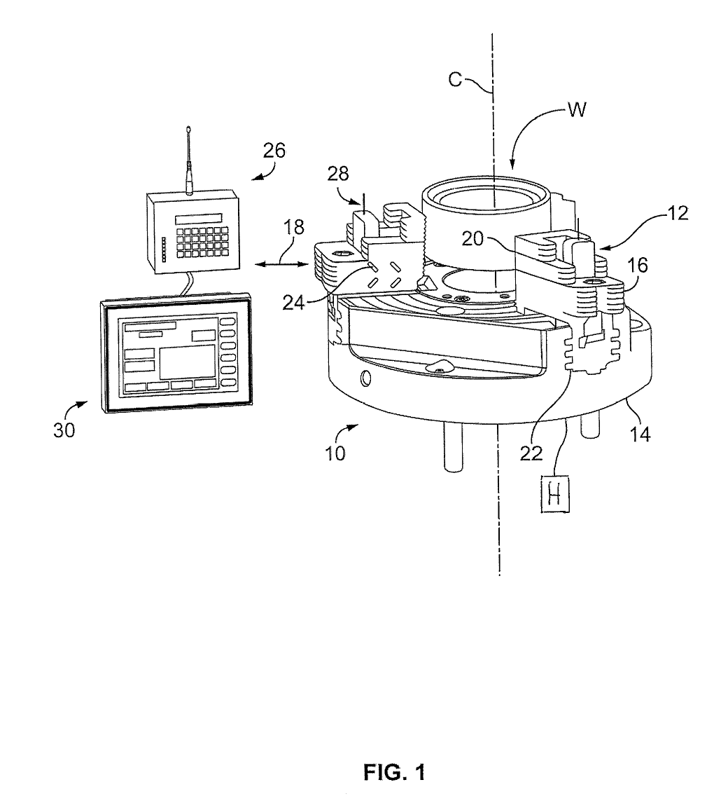

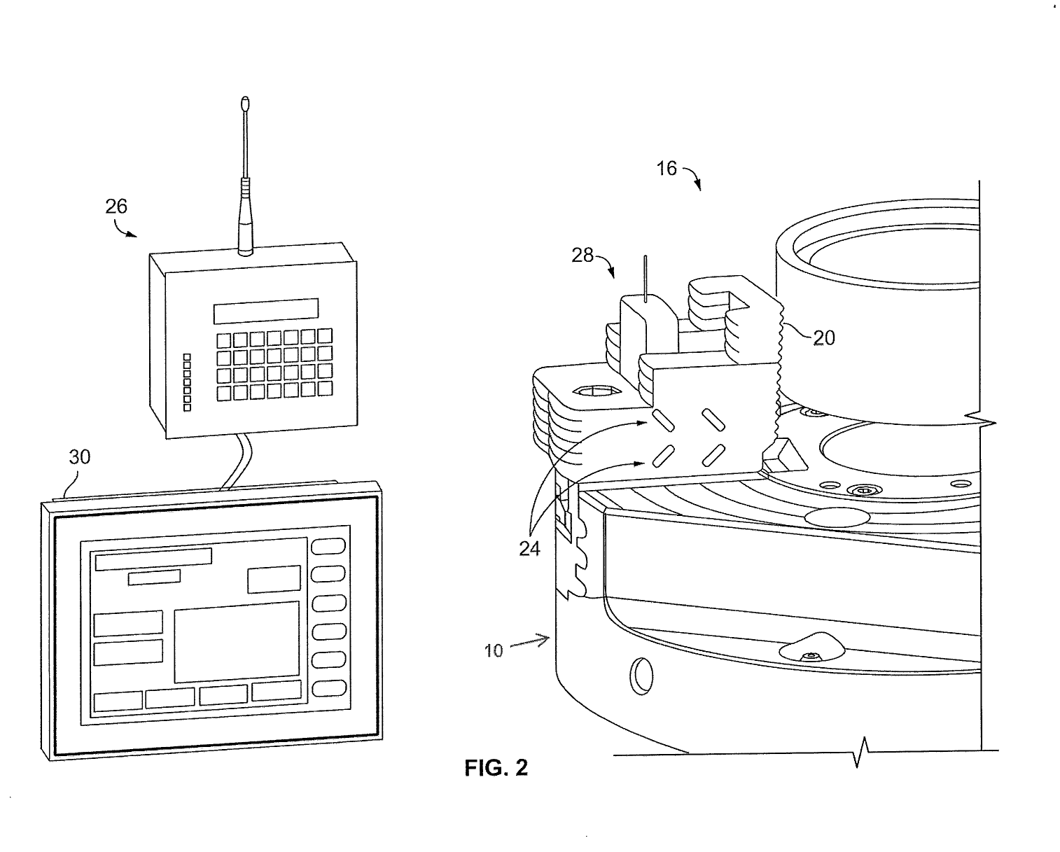

Referring to figures, and in particular to FIG. 1, there is shown an embodiment of a chuck 10 with a jaw arrangement 12 for exerting a constant holding force on the workpiece W. The chuck 10 is shown without any machine tools, drives, or the like for ease of illustration. However, it will be appreciated that typically, the chuck 10 is used to hold a workpiece W that is rotated by a drive and is being operated on by the machine tool. The illustrated chuck 10 is configured for external gripping of the workpiece W—that is, gripping the workpiece W on an outer surface and exerting an inward clamping force.

The chuck 10 includes a base element 14 (also referred to herein as “base”) that is mounted for rotation by the drive (not shown). Jaw elements 16 (also referred to herein as “jaw(s)”) are mounted to the base 14 that move radially toward and away (as indicated by the arrow at 18) from the longitudinal center C to clamp and release the workpiece W. The jaws 16 typically include a contact point or surface 20 that contacts the workpiece W. The jaws 16 are maintained in a track or guide 22 to assure smooth movement to clamp and release the workpiece W.

The system includes means for moving the jaws 16 relative to the center C. In the illustrated arrangement, the jaws 16 are controlled (moved) by a hydraulic system H, which will be readily understood by those skilled in the art. Other means includes mechanical drives, electro-mechanical drives, e.g., servomotors, and the like.

Strain gauges or load cells 24 are located on each of the jaw elements 16. The strain is transmitted to a receiver/reader 26. Preferably, transmission is by a wireless transmitter 28 to preclude hardwiring the system and to eliminate wires extending from the jaws 16. Wireless technology can be, for example, transponder (active or passive RFID technology) or like wireless protocols that will be understood by those skilled in the art.

The control system 30 (also referred to herein as the “controller”, which may include the reader/receiver) can include, for example, an analog to digital (A/D) converter, EEPROM, and a microprocessor (shown at 30) to process the signal and convert it to an equivalent jaw clamping force. Software will compare the measured jaw clamping force to a required clamping force and signal the controller to increase or decrease the hydraulic pressure (to increase or decrease the clamping force) as necessary. Continuous monitoring of the clamping force and adjustment of the hydraulic system pressure enhances the safety of the chuck 10, and the quality and productivity of the control system 30.

In addition, the control system 30 will determine (calculate) the theoretical required clamping load based on the speed of the chuck 10, and the mass and center of gravity of the jaws 16. The control system 30 will use the higher of the clamping force (measured vs. calculated) as the required clamping force applied. It will be appreciated that this arrangement (the self-contained jaw elements 16) provides self-identification (each jaw can be uniquely identified), and is self-calibrating and field programmable/reprogrammable, and has wireless connectivity in a compact readily installed/replaceable assembly.

In that the strain gauges 24 and the transmitters/transponders 28 are located in the jaws 16, and are all preferably wireless, the jaws 16 can be readily replaced without affecting the functionality of the chuck 10 and control system 30. Because each set of jaws 16 will have a unique identifier associated with it, the mass, center of gravity, and other pertinent information about each set of jaws 16 can be stored for easy retrieval. Power to the transmitter 28 can be provided by a rotary generator (not shown), or a power source can be provided though an electrical induction arrangement/circuit. Alternately, a remote power system with, for example, a small rechargeable battery can be used.

It will be appreciated that the present chuck 10 and control system 30 can result in reduced cycle time for the machine tool. Moreover, a low initial clamping force allows the machining of fragile parts at higher machine speeds. In addition, safety is enhanced in that the clamping force is continuously monitored and a lower force established, below which the force will not decline.

It will also be appreciated that a greater range of (upper) operating speeds can be achieved. It is anticipated that lighter weight chucks 10 may be used in that initial clamping forces can be reduced. This can provide cost savings in materials, as well as fabricated equipment items, such as spindles, drives/motors, controllers and the like, which can also result in reduced power requirements (and power costs).

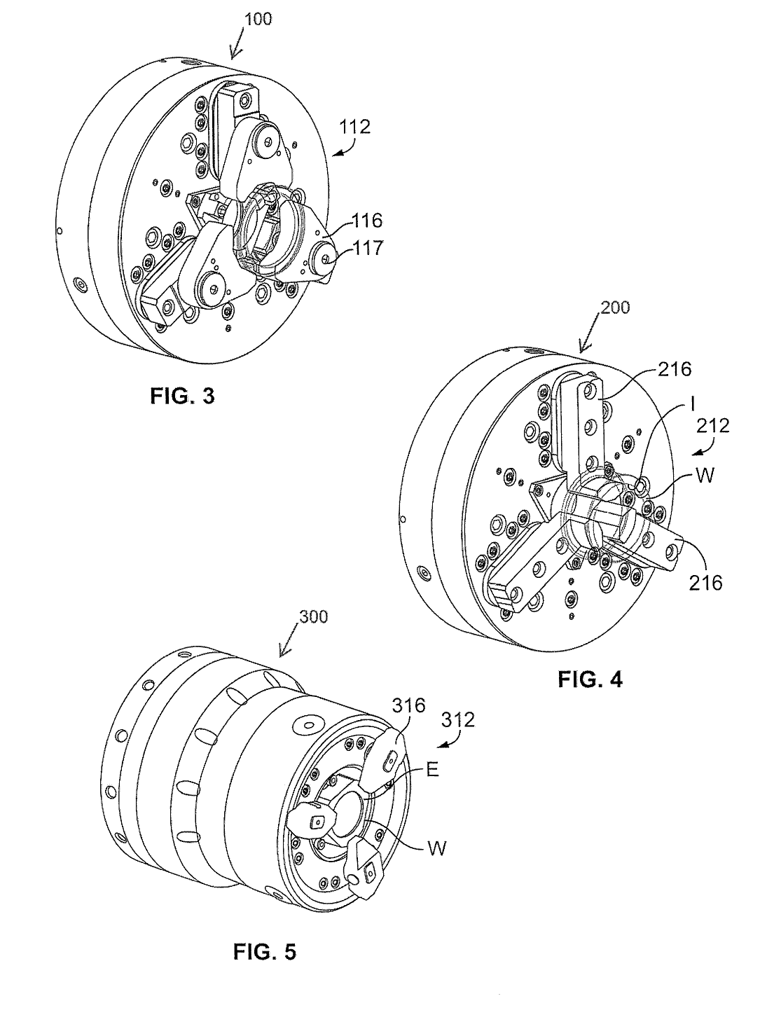

An alternate embodiment of the chuck 100 with an external gripping arrangement 112 is illustrated in FIG. 3. In this embodiment, the jaw elements 116 are mounted on a pivot 117 so as to allow for proper centering and adjustment of the jaw elements 116 to accommodate the workpiece W. Otherwise, the structure and operation of the chuck 100 is similar to that of the previous embodiment.

An embodiment of the chuck 200 with an internal gripping arrangement 212 is illustrated in FIG. 4. In this embodiment, the jaw elements 216 move outwardly to engage an interior surface I of the workpiece W (shown in outline). It will be appreciated that in such an arrangement, the clamping force exerted by the jaw elements 216 is an outward force that will increase with increased rotational speed. As such, the force exerted on the workpiece W increases as the rotational speed increases. In this arrangement, the clamping force exerted by the jaw elements 216 will decease as the rotational speed increases to prevent exerting excessive clamping forces on the workpiece W. As in the earlier embodiments, the control system 30 (shown in FIG. 1) will calculate the theoretical required clamping load based on the speed of the chuck 200, and the mass and center of gravity of the jaws 216. The control system 30 will use the lower of the clamping force (measured vs. calculated) as the required clamping force applied, e.g., to apply a constant clamping force. Control systems, monitoring, hydraulics and the like (not shown), similar to the previous embodiments are anticipated with the internal clamping arrangement.

Still another embodiment of a chuck 300 is illustrated in FIG. 5. This arrangement is an axial or end gripping arrangement 312. In this arrangement the jaws 316 grip the workpiece W on an end E (as opposed to an exterior or interior surface) and hold the piece in the chuck 300 by virtue of clamping the workpiece W between the (moveable) jaws 316 and a stationary portion of the chuck (not shown), such as an inside surface of the chuck. In this arrangement, the jaws 316 would tend to pull back toward the body of the chuck 300, or move outwardly, as the speed of the chuck 300 increases. Excessive axial gripping force on the workpiece W can result in distortion of the workpiece W, while insufficient axial force on the workpiece W can allow the workpiece W to move during machining.

As in the earlier embodiments, in an axial griping arrangement of the present system, the control system 30 (as shown in FIG. 1) will calculate the theoretical required clamping load based on the speed of the chuck 300, and the mass and center of gravity of the jaws 316. The control system 30 will use the lower of the clamping force (measured vs. calculated) as the required clamping force applied, e.g., to apply a constant clamping force. Control systems, monitoring, hydraulics and the like (not shown), similar to the previous embodiments are anticipated with the axial clamping arrangement.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the invention.

What is claimed is:

1. A rotatable chuck for securing a workpiece in a machine, comprising:
a base element having a longitudinal center;
a plurality of jaw elements movable to clamp the workpiece, the jaw elements exerting a measurable clamping force on the workpiece;
means for measuring the clamping force exerted on the workpiece;
means for moving the jaw elements to vary the clamping force exerted on the workpiece; and
comparison means for comparing the measured clamping force to a predetermined clamping force,
wherein the jaw elements are movable, as the chuck is rotating, to adjust the clamping force on the workpiece relative to the predetermined clamping force.

2. The rotatable chuck in accordance with claim 1 wherein the jaw elements are movable toward the center to clamp the workpiece.

3. The rotatable chuck in accordance with claim 1 wherein the jaw elements are movable away from the center to clamp the workpiece.

4. The rotatable chuck in accordance with claim 1 wherein the jaw elements are movable longitudinally along the center to clamp the workpiece.

5. The rotatable chuck in accordance with claim 1 wherein the means for measuring the clamping force is a load cell.

6. The rotatable chuck in accordance with claim 1 wherein the means for measuring the clamping force is a strain gauge.

7. The rotatable chuck in accordance with claim 1 wherein the means for moving the jaw elements is a hydraulic system.

8. The rotatable chuck in accordance with claim 1 wherein the comparison means is a controller.

9. The rotatable chuck in accordance with claim 1 including a wireless transmitter for transmitting the measured clamping force.

10. The rotatable chuck in accordance with claim 9 wherein the 1 transmitter is disposed on or proximal to a respective jaw element.

11. The rotatable chuck in accordance with claim 1 wherein the clamping force is adjusted to maintain a substantially constant clamping force on the workpiece throughout chuck rotation at varying speeds of rotation.

12. The rotatable chuck in accordance with claim 1 including means for measuring the clamping force exerted on the workpiece associated with each of the plurality of jaw elements.

13. The rotatable chuck in accordance with claim 9 including a wireless transmitter associated with each of the plurality of jaw elements for transmitting the measured clamping force.

14. A rotatable chuck for securing a workpiece in a machine, comprising:
a base element having a longitudinal center;
a plurality of jaw elements movable to clamp the workpiece, the jaw elements exerting a measurable clamping force on the workpiece;
means associated with each of the plurality of jaw elements for measuring the clamping force exerted on the workpiece;
a drive for moving the jaw elements to vary the clamping force exerted on the workpiece; and
a control system, the control system adapted to compare the measured clamping force to a predetermined clamping force,
wherein the jaw elements are movable, as the chuck is rotating, to adjust the clamping force on the workpiece relative to the predetermined clamping force.

15. The rotatable chuck in accordance with claim 14 wherein the means for measuring the clamping force includes a strain gauge or a load cell.

16. The rotatable chuck in accordance with claim 14 wherein the drive is a hydraulic drive.

17. The rotatable chuck in accordance with claim 14 including a wireless transmitter associated with each of the plurality of jaw elements for transmitting the measured clamping force.
